(19) United States
(12) Patent Application Publication
(10) Pub. No.: US 2013/0093637 A1
(43) Pub. Date: Apr. 18, 2013

(54) ANTENNA DIELECTRIC CAP LOADING

(71) Applicant: Mervi Hirvonen, Espoo (FI)

(72) Inventor: Mervi Hirvonen, Espoo (FI)

(73) Assignee: TEKNOLOGIAN TUTKIMUSKESKUS VTT, Espoo (FI)

(21) Appl. No.: 13/702,587

(22) PCT Filed: Jun. 9, 2011
(86) PCT No.: PCT/FI2011/050539

§ 371 Date: Jan. 7, 2013

(30) Foreign Application Priority Data
Jun. 10, 2010 (FI) 20105656

(51) Int. Cl. H01Q 9/04

(52) U.S. Cl. CPC H01Q 9/0485
USPC 343/749

(57) ABSTRACT

Antenna miniaturization is a big engineering challenge because of the fundamental limitations that restrict antenna performance. In the present invention a new dielectric cap loading technique for improving small antenna element performance exploiting the space capacitance is introduced. The cap loading technique can be easily realized e.g. by 3D dielectric blocks, such as ceramic blocks.

### BACKGROUND

1. Field of Invention

The present invention relates to antenna technology. In particular, the invention relates to a new dielectric loading technology for antennas, more specifically for small antennas, which improves the performance of modified antenna elements. Specifically, the present invention relates to an antenna construction according to the preamble of claim 1.

2. State of the Art

Antennas are integral components of modern wireless devices. As there is a trend for miniaturizing devices, so there is a need to miniaturize antennas. However, there are fundamental limitations that restrict antenna size in relation to performance.

Antenna miniaturization is an engineering challenge because of the fundamental limitations that restrict antenna performance. The use of permeable, or magnetic, materials as antenna substrates in traditional antenna element design has been proposed as a possible solution to the problem. However, exploiting permeability is not straightforward as natural magnetic materials lose their useful properties at higher frequencies.

Nanoparticle technology has been able to demonstrate higher frequency permeability but these substances are toxic and not readily available. Additionally, some antenna performance enhancement has been realized with artificial composite materials acting as magnetic or metamaterials, although in these cases the performance is limited by dispersion and is a challenge in implementation.

In 1973 Landstorfer and Meinke [“A new equivalent circuit for the impedance of short radiators”, Report from the Institute for High-Frequency Engineering of the Technical University Munich, Originally published in German in “Nachnchtentechnische Zeitschnft”, vol. 26 (1973), no. 11, p. 490-495] published a report where different field zones produced by a dipole element were divided to represent different capacitance regions. In principal, Landstorfer and Meinke suggested that a dipole contains two capacitance regions: one between physical antenna branches and the other between the element and the infinity. The first being destructive since the energy is bound to the non-radiating near fields and the other an improving one as the energy is flowing to infinity, therefore adding radiation.

Antenna size, bandwidth and radiation efficiency are known to be trade-off features. An important measure for small antennas is quality factor Q=(ω*W)/P, where ω is angular frequency, W is stored energy and P is the overall power (radiated power Pᵣ+loss power Pₗₒₛₛ) accepted by the antenna. In a simple case, quality factor may also be considered as inversely proportional to the bandwidth, B ∝ 1/Q, thus making low Q factors desirable.

Material loading has an effect on both stored energy as well as radiated power. Radiated power is related to antenna radiation efficiency as η=Pᵣ/(Pₗₒₛₛ+Pᵣ). A fair estimate for antenna Q using antenna input impedance is Q≈[ω/(2* [symbol] {Z})]*|dZ/dω|.

### SUMMARY OF THE INVENTION

It is an object of the present invention to provide a technology that overcomes at least some of above mentioned problems relating to antenna miniaturization and small antennas.

It is a particular object of the present invention to provide exemplary optimized designs for dielectric cap structures on a variety of antenna element designs, more specifically, to provide ideal and practical optimized designs for at least dipole antennas and loop antennas.

The object is achieved through the use of dielectric cap loading of antenna elements as hereinafter described and claimed.

The invention is based on the idea of providing an antenna comprising an antenna element and an antenna input located on the antenna element at a first position.

According to one aspect of the invention there is located at least one set of opposing dielectric loading elements on the antenna element, on different sides of the antenna input, the dielectric loading elements separated by a gap. Thus, dielectric “caps” electromagnetically coupled to the antenna element are provided in order to change the radiation properties of the antenna element.

According to another aspect of the invention, there is provided at least one dielectric loading element coupled to a portion of a surface of the radiative antenna element which is located on one side of the antenna input and comprising a conductive ground plane located on another side of the antenna input.

More specifically, the antenna construction according to the invention is characterized by what is stated in the characterizing portion of Claim 1.

The antenna element may be, for example a linear element (generally a dipole antenna) or a circular, elliptical or rectangular element (generally a loop antenna). Alternatively, it may be a monopole element.

According to one embodiment, the dielectric loading elements are arranged in direct contact with the antenna element. Additionally, the dielectric loading elements are typically arranged symmetrically on different sides of the antenna input point.

At least four dimensions can be used to characterize the present antenna design. The first is the gap between the opposing loading elements, the second is the dimension of the loading elements in a first direction spanned by the loading elements and the antenna input point (first axis), the third and fourth being the height and width of the antenna elements in a plane perpendicular to said first direction (along second and third axis). In the case of a dipole antenna, the first direction is typically the same as the direction of the dipole antenna element.

According to one embodiment, the gap between the opposing dielectric structures is between 10% and 90%, preferably between 50% and 70%, of the dimension of the antenna element in the first direction.

According to one embodiment, the dimension of the loading elements in the first direction is 30-50%, in particular 35-45, preferably about 40% of a corresponding dimension of the antenna element divided by two, that is, the radius or half-length of the antenna (usually a dimension measured from a center of symmetry of the antenna element to the peripheral end of the antenna element).

In particular, the dielectric loading elements may be located essentially “inwards” from peripheral ends of the antenna element. For example, in a cap-loaded dipole antenna, the loading elements are completely contained in a circle or sphere having said radius and drawn around the input point. In a cap-loaded loop antenna, the dielectric loading elements are shaped to be contained in a sphere or ellipsoid whose radius or main axes of curvature are specified by the radius or main axes of the radius or main axes of the loop, or located within said sphere or ellipsoid.

The loading elements can be three dimensional, e.g. segments of a sphere, or planar, e.g. slice projections of a sphere, preferably located in a plane co-planar with the plane defined by the antenna element.

According to one embodiment the dimensions of the loading elements perpendicular to the first direction, height or width, are smaller than the dimension of the antenna element in the first direction. Alternatively, the dimensions of the loading elements perpendicular to the first direction are large and can even be larger than the dimension of the antenna element in the first direction.

Considerable advantages are gained with the aid of the present invention. Through dielectric cap loading it is possible to increase the space capacitance of a small antenna which results in a decrease to an antenna's Q factor. This leads to an increase in small antenna element performance, such as increased bandwidth and/or radiation efficiency.

Although illustrated with the aid of dipole and loop antenna designs, one of ordinary skill in the art will recognize that the principles outlined herein can be applied to an endless variety of current and future antenna designs.

The present invention will now be described in more detail with the aid of the figures and exemplary embodiments.

### BRIEF DESCRIPTION OF THE DRAWINGS

FIG. 1A shows the top view of a basic dipole antenna element having two dielectric structures.

FIG. 1B shows a side view of the antenna element of FIG. 1A.

FIG. 1C shows an end-on view of the antenna element of FIG. 1A.

FIG. 1D shows an end-on view of an alternative element similar to FIG. 1A.

FIG. 2A shows the top view of a modified bow-tie dipole antenna.

FIG. 2B shows a side view of a first embodiment with four dielectric structures on the modified bow-tie dipole antenna of FIG. 2A.

FIG. 2C shows a side view of a second embodiment with four dielectric structures on the modified bow-tie dipole antenna of FIG. 2A.

FIG. 2D shows a side view of a third embodiment with four dielectric structures on the modified bow-tie dipole antenna of FIG. 2A.

FIG. 2E shows an end-on view of the antenna element of FIG. 2B.

FIG. 2F shows an end-on view of the antenna element of FIG. 2C.

FIG. 2G shows an end-on view of the antenna element of FIG. 2D.

FIG. 3A shows the top view of a loop antenna element having two dielectric structures.

FIG. 3B shows a side view of the loop antenna element of FIG. 3A.

FIG. 3C shows a side view of an alternative loop antenna element similar to the element in FIG. 3A with two additional dielectric structures.

FIG. 3D shows an end-on view of the antenna element of FIG. 3B.

FIG. 3E shows an end-on view of the antenna element of FIG. 3C.

FIG. 4A is a graph of Q factors verses the ratio of the gap between cap dielectric structures and dipole element radius a of a wire dipole case and for a dipole element radius of 0.2/k, where k is the operating wave number and the various lines represent various dielectric materials.

FIG. 4B is a graph of Q factors verses the ratio of the gap between cap dielectric structures and dipole element radius a of a wire dipole case and for a dipole element radius of 0.3/k, where k is the operating wave number and the various lines represent various dielectric materials.

FIG. 5a is a graph of Q factors verses the ratio of the gap between cap dielectric structures and loop element radius a of an element according to FIG. 3A and for a loop element radius of 0.3/k, where k is the operating wave number and the various lines represent various dielectric materials.

FIG. 5b is a graph of Q factors verses the ratio of the gap between cap dielectric structures and loop element radius a of an element according to FIG. 3A and for a loop element radius of 0.3/k, where k is the operating wave number and the various lines represent various dielectric materials.

FIGS. 6a, 6b and 7-9 show variations of the invention in the case of a monopole antenna.

### DETAILED DESCRIPTION OF EXEMPLARY EMBODIMENTS

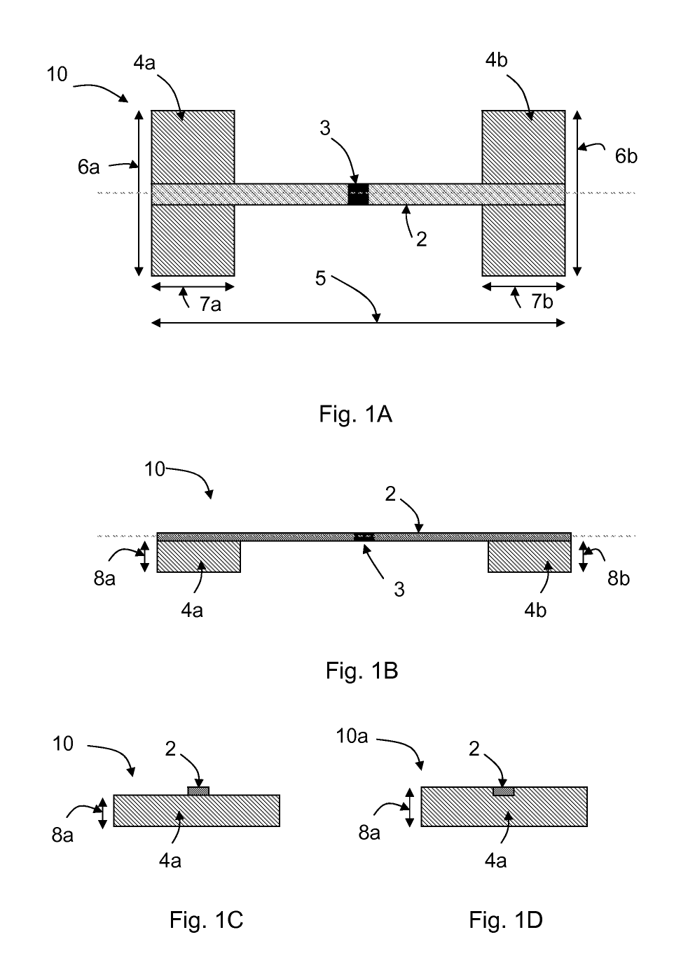

The present invention of dielectric cap loading on antenna elements can be realized in a variety ways using a variety of designs. FIG. 1A shows a simple exemplary embodiment of the present technology used in connection with a dipole antenna element.

The dipole element 2 has an overall length 5 which extends from a first terminal end on the left to a second terminal end on the right. Additionally, the dipole element has an antenna input 3 located along the dipole element length essentially bisecting the two terminal ends.

Located at each end of the dipole element 2 is a structure 4a, 4b. These structures can be metallic, dielectric or other material which increases antenna performance. However, the present invention is directed mainly at the use of dielectric material as it has distinct advantages over other known materials. The most notable advantages to dielectric material are that its relatively inexpensive and easy to use and realize with regards to the present invention in current manufacturing situations.

The antenna dipole element 10 has dielectric structure 4a starting at the first terminal end of the dipole and extending a distance 7a along the length of the dipole element. Similarly, dielectric structure 4b is located on the same surface of the dipole element 2 but beginning at the second terminal end and extending a distance 7b along the length of the dipole element. While it is conceivable that distances 7a and 7b are different, it is normally preferable that they are the same, or substantially similar.

Distances 7a and 7b range from 5% of length 5 to 45% of length 5, preferably from 10% to 30% of length 5, and most suitably around 20% of length 5. Dielectric structures 4a and 4b also have widths 6a and 6b respectively and heights 8a and 8b respectively. The widths and heights of the dielectric structures can vary greatly in both dimension and geometry. Selecting the dimensions and geometry of dielectric structures is often influenced by physical constraints of antenna placement, desired performance increase and ease of manufacture.

FIG. 1A shows a top view of antenna element 10 with dielectric structures 4a and 4b having a constant width 6a and 6b respectively. FIG. 1B shows a side view of antenna element 10. FIGS. 1C and 1D show alternative end-on views of antenna element 10 and 10a. FIG. 1C shows dielectric structure 4a having a constant height and beginning from the bottom surface of dipole element 2. FIG. 1D shows a dielectric structure 4a having a constant height but beginning from the level of the top surface of the dipole element 2 and effectively encasing the sides and bottom of the dipole element. The dielectric structure can also only extend a portion of the way up the sides of the dipole element (not shown).

FIGS. 1A-1D show a simplistic case of the present technology applied to a generic dipole. The structure elements 4a and 4b can be of virtually any shape including rectangular, cylindrical or spherical, or a segment of any of these, to name a few. Additionally, they can be of various dimensions, applied to various shaped and sized dipoles and made of various materials. The following figures show some other exemplary designs according to the present invention.

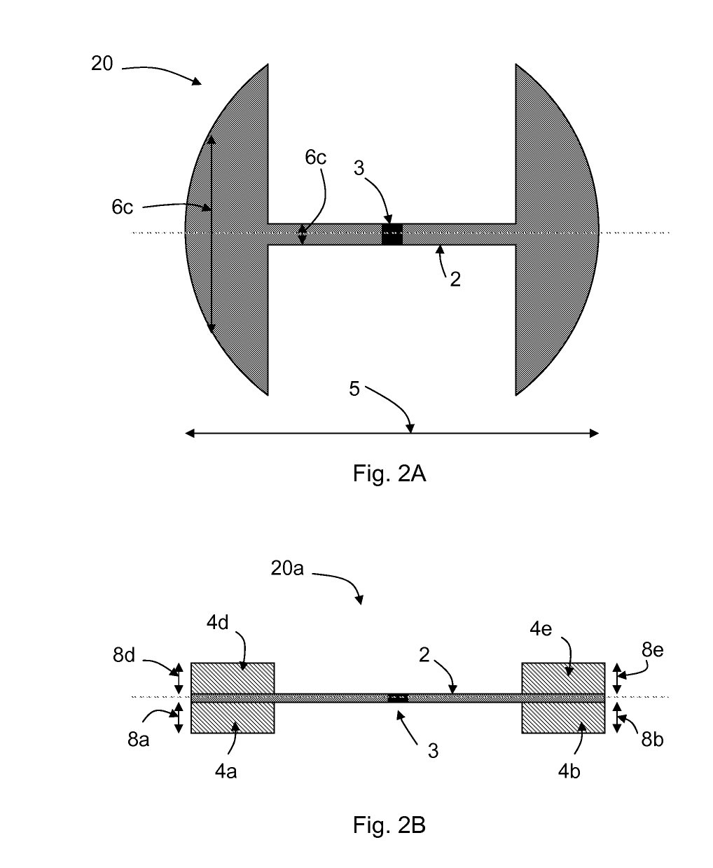

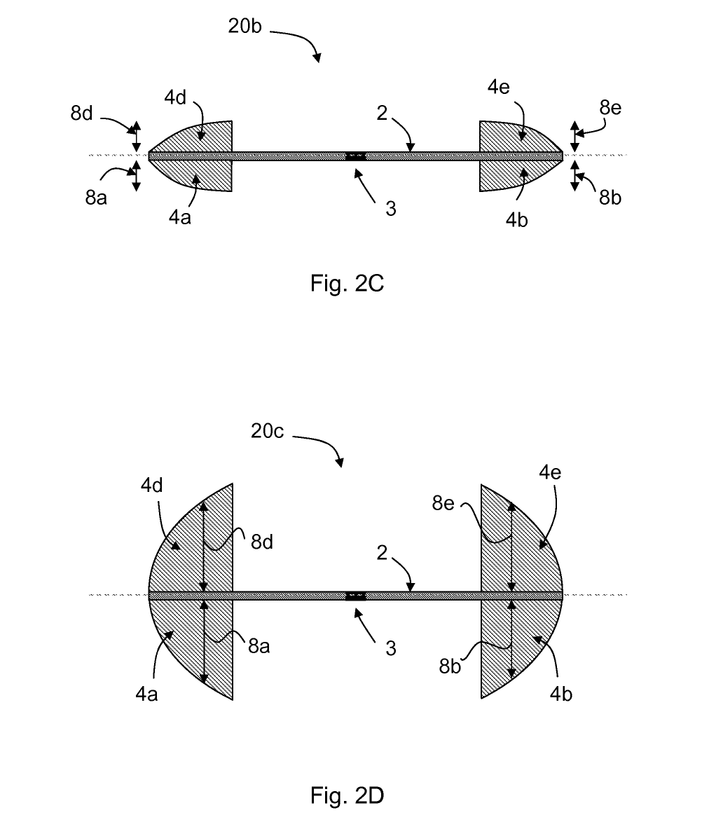

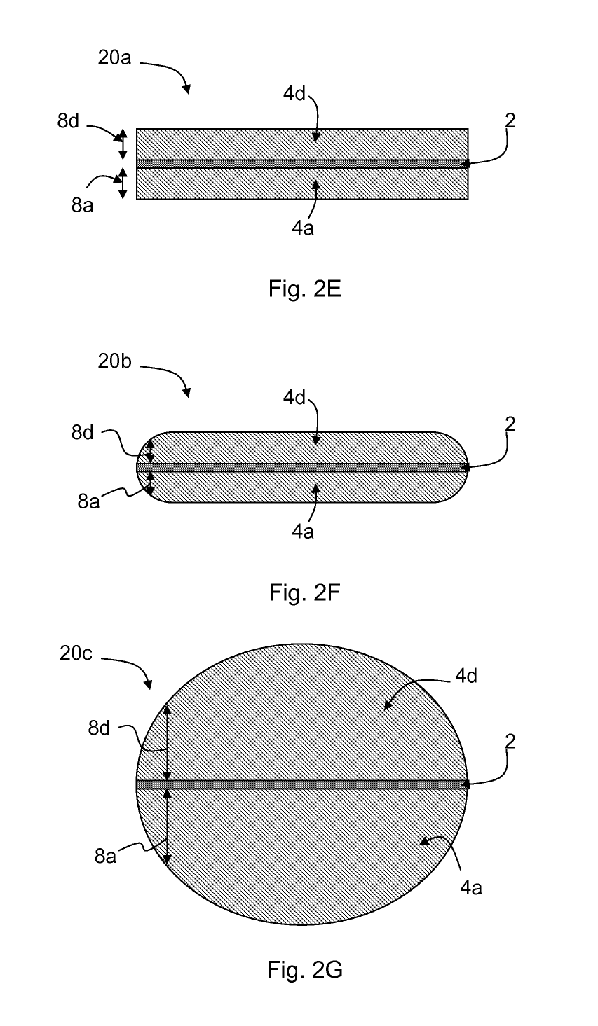

FIG. 2A shows a generic dipole element 2 of a generic antenna element 20 which has a width 6c which varies along its length. FIG. 2B shows a side view of one example 20a which has two dielectric structures 4a and 4d located at a first terminal end on the top and bottom surfaces of the dipole element from FIG. 2A respectively and two additional dielectric structures 4b and 4e located at the second terminal end on the top and bottom surfaces of the dipole element respectively.

The dielectric structures of antenna element 20a preferably conform to the geometry of the dipole element 2. However, the structures could be larger, smaller or of a different shape all together. FIG. 2C shows a similar structure 20b to that of FIG. 2B, 20a, but where the heights 8a, 8b, 8d, 8e of the dielectric structures vary along the length covered of the dipole. As will be seen in FIGS. 2E-G, while the heights vary along the length of the dipole element, they may be constant, substantially constant, or variable along the width of the dielectric structures.

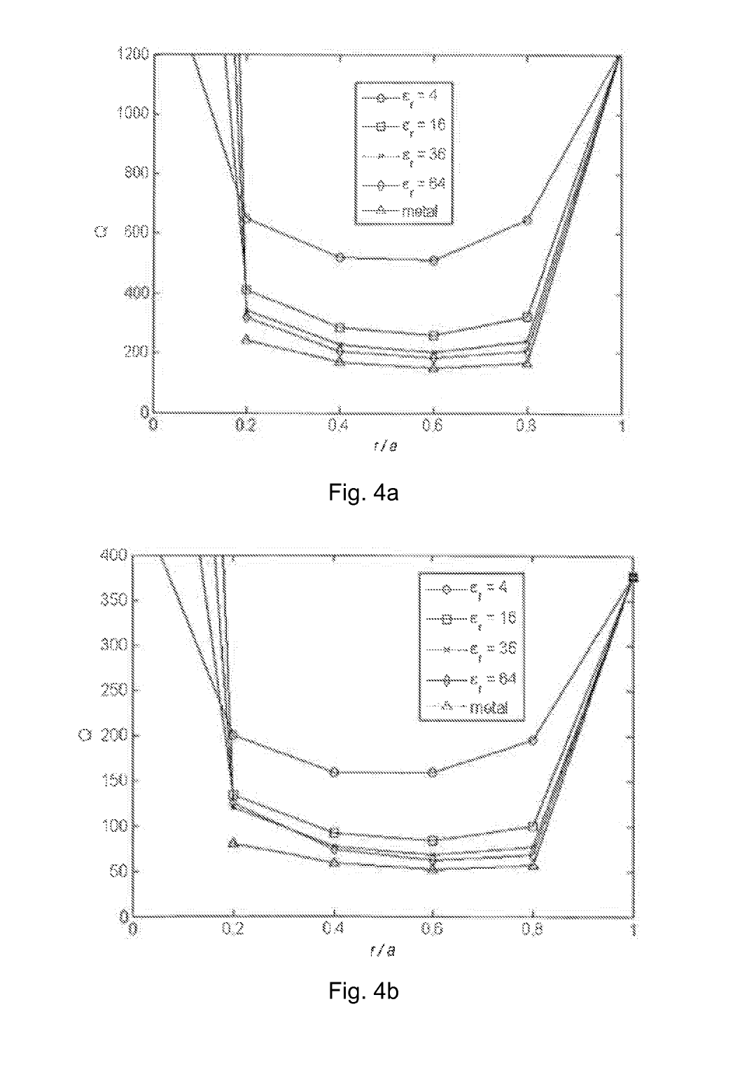

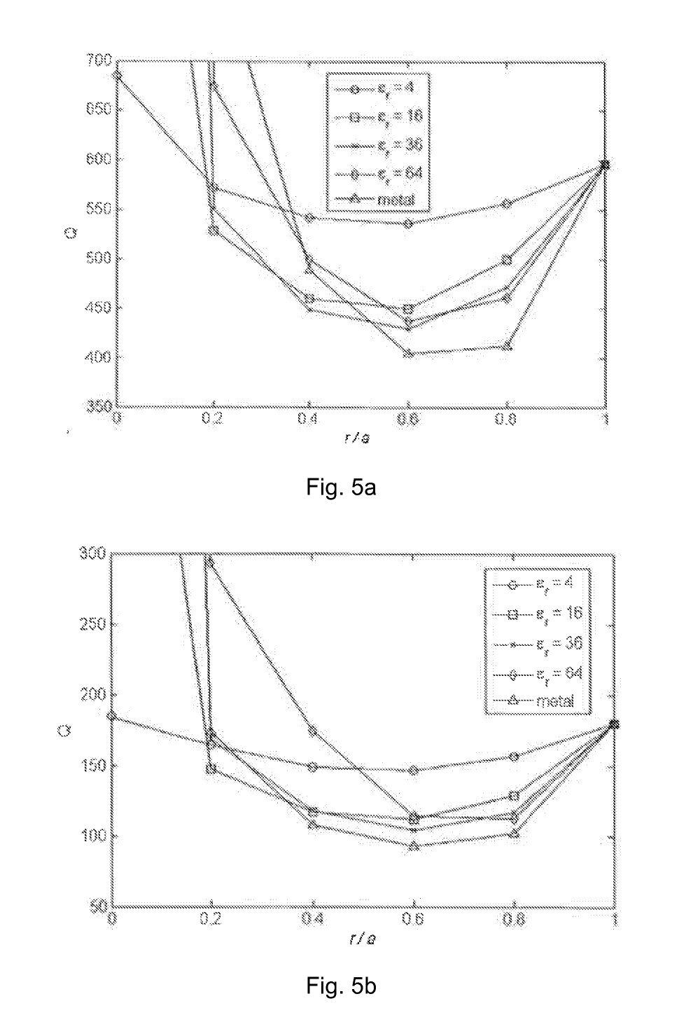

Examples 20a and 20b can have substantial heights, or the overall height of the dielectric structures can be relatively small. It is often advantageous, both in terms of cost as well as manufacture, to have only relatively small heights to the dielectric structures. These cases are considered to be “slice” cap loading. As will be described in more detail with regards to the “slice” loading tables 1-3, the overall increased performance of small height dielectrics is small compared to large height/mass embodiments (see the graphs presenting spherical cap loading in FIGS. 4-5), it is still capable of noticeable performance improvement.

Example 20c shown in FIG. 2D is one of the large height embodiments which is considered to be spherical cap loading. In this embodiment, as seen in conjunction with FIG. 2G, the dielectric structures resemble portions of a sphere attached at each terminal end of the dipole.

FIGS. 2E-G show end-on views of example antenna elements 20a, 20b and 20c. The spherical cap design of example 20c can clearly be seen in FIG. 2G while the relative “slice” or thin design of examples 20a and 20b can be seen in FIGS. 2E and F respectively. While the figures show the dielectric structures covering the whole width of the dipole element 2, and not extending past the terminal ends, it is conceivable that the dielectric structures can cover more or less than the width of the dipole element or extend some distance past or begin some distance indented from the terminal ends.

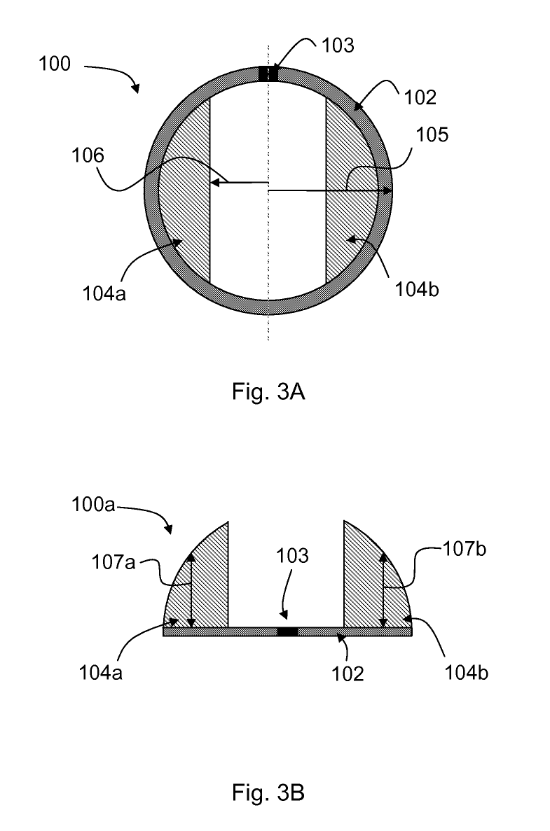

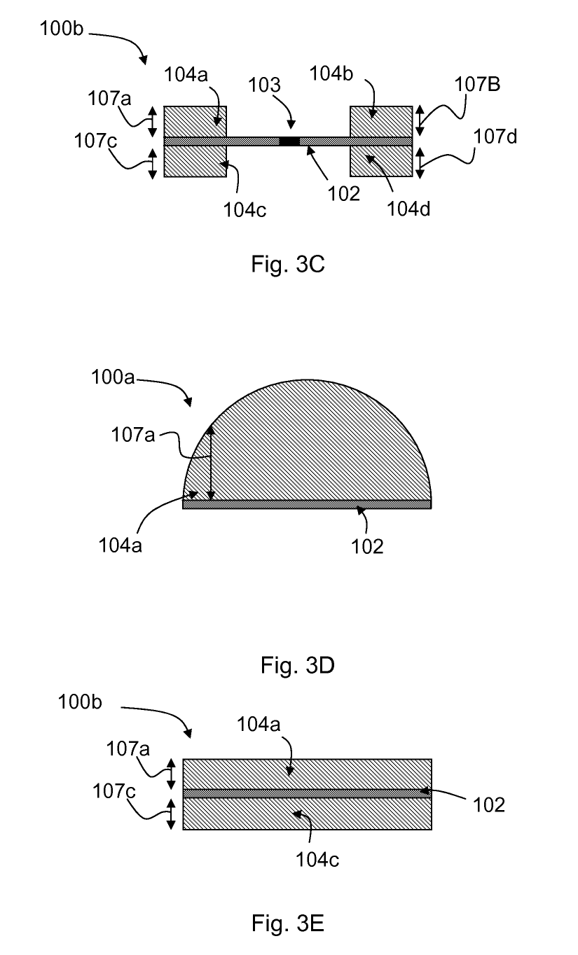

Another common antenna design, apart from the dipole antenna, is the loop antenna. A loop antenna can be circular, as shown in FIG. 3A, or elliptical, not shown. FIG. 3A shows a top down view of a loop antenna 100 having a loop antenna element 102 with radius 105, an antenna input 103 located at a point along a first axis, and two dielectric structures 104a and 104b located opposite from each other and spaced equidistance from the first axis at a distance of 106.

FIGS. 3B and 3D show a side view and end-on view of a first example loop antenna element 100a in which the dielectric structures 104a and 104b are located on one side of the antenna element and resemble half spherical caps with varying heights 107a and 107b respectively. The graphs in FIGS. 5A and 5B are directed to a case similar to 100a but with additional dielectric structures on the opposite side of the antenna element creating a full capped loop.

FIGS. 3C and 3E show a side view and an end-on view of a second example loop antenna element 100b in which the dielectric structures 104a and 104 are located on one side of the antenna element, dielectric structures 104c and 104d are located on the opposite side of the antenna element, and all dielectric structures have a constant height across the entire structure.

The antenna element examples 10, 10a, 20a-c, 100a and 100b, are not meant as an exhaustive list of embodiments but as a examples in which the various dimensions and geometries of the present invention can vary and be realized. The following is a discussion of several discrete exemplary examples of the present technology and the performance increase that they provide to the antenna operation.

The space capacitance of a dipole element is increased by loading the antenna with metallic or dielectric structures, such as spherical caps. In practice, metallic 3D structures, for example bi-conical dipole, are hard to manufacture and difficult to use. In that sense dielectric 3D, or semi-3D, structures are more attractive. To realize the full potential of the present technology, the dielectric material should have a permittivity εᵣ>>1, preferably around the order of 10-80.

Simulated Q values for different permittivity values and cap sizes are presented in FIGS. 4A and 4B. All of the cases are considered lossless and two dipole cases are presented. In FIG. 4A is presented a wire dipole antenna element with a=0.2/k. Wherein a is the radius of the smallest sphere enclosing the dipole, roughly ½ of length 5 and k is the wave number k=2π/λ. The width of the dipoles is a/25. FIG. 4B shows the same dipole antenna element but with a=0.3/k.

As can be seen from the results in the graphs of FIGS. 4A and 4B, with optimized dielectric cap loading the Q value may be decreased up to 85% compared to the free space wire antenna case. However, when compared to optimized metallic cap loading, optimized dielectric loading leads to 20% higher values.

In reality, cap loading can be expensive to realize. However, even if presented as a “slice”, the cap loading improves performance as seen in Tables 1 and 2 below. Slice dielectric loading leads to a decrease in Q value of up to 75% (depending on the thickness of the dielectric) when compared to the wire dipole in free space. When compared to the modified bow tie antenna in free space, slight improvements are still seen. More importantly, the Q factor of a modified bow-tie or similar structures such as example 20 can be decreased up to 25-30% with dielectric loadings such as 20a and 20b. A metallic 2D structure is easily realizable and 3D dielectric caps can be attachable with current Printed Circuit Board, PCB, or Integrated Passive Device, IPD, processes.

Table 1 with Q factors for a=0.2/k size wire dipole and modified bow-tie dipole of example 20a with slice cap loading, εᵣ,=64, gap between the structures 4a and 4b=0.6*a and wherein the height is the fraction of the operating wavelength λ.

TABLE 1

| h[λ] | wire dipole | modified bow tie |
|---|---|---|
| 0 | 1218 | 332 |
| 0.003 | 352 | 279 |
| 0.006 | 300 | 247 |
| 0.009 | 273 | 227 |

Table 2 with Q factors for a=0.3/k size wire dipole and modified bow-tie dipole of example 20a with slice cap loading, εᵣ,=64, gap between the structures 4a and 4b=0.6*a and wherein the height is the fraction of the operating wavelength λ.

TABLE 2

| h[λ] | wire dipole | modified bow tie |
|---|---|---|
| 0 | 377 | 105 |
| 0.003 | 120 | 92 |
| 0.006 | 103 | 85 |
| 0.009 | 95 | 79 |

In addition to the dipole case, spherical cap loading also improves the performance of a loop structure as in FIGS. 3A-E. The simulated Q values for different permittivity values and cap sizes are presented in FIGS. 5A and 5B.

In FIG. 5A is presented a loop antenna element similar to 100a according to FIGS. 3A, 3B and 3D but with symmetrical structures on the opposite side of the antenna loop 2 to form a complete spherical cap loading, and with a=0.2/k. Wherein a is the radius of the smallest sphere enclosing the loop, roughly radius 105 and k is the wave number k=2π/λ. The width of the loop is a/25. FIG. 5B shows the same dipole antenna element but with a=0.3/k. As can be seen from the results, with optimized dielectric cap loading the Q value may be decreased up to 28-45% compared to the free space case.

A more easily realizable “slice” loop structure such as 100b as presented in FIGS. 3C and 3E has results reported in Table 3. The Loop does not benefit from metallic slicing since the loop circumference gets smaller so any metallic slicing should be done in a perpendicular plane. However, a 3D structure would still be evident. With optimized dielectric 3D loadings the Q value may be decreased up to 15%, depending on the thickness of the dielectric.

Table 3 with Q factors for loop of example 100b with “slice” cap loading, εᵣ,=36, distance 106 being r=0.6*a and wherein the height is the fraction of the operating wavelength λ.

TABLE 3

| h[λ] | a = 0.2/k | a = 0.3/k |
|---|---|---|
| 0 | 596 | 180 |
| 0.003 | 556 | 158 |
| 0.006 | 539 | 152 |
| 0.009 | 519 | 146 |

Loading of antenna elements, specifically with dielectrics, as shown herein is a novel approach to increasing antenna performance without the need of using expensive materials or significantly increasing the size of antenna elements. While the examples have been directed to dipole and loop antennas, the present technology is applicable to all known antenna designs and geometries which can benefit from such loading. Furthermore, one of ordinary skill in the art will recognize that materials, designs and geometries not explicitly disclosed herein can be used with the present technology without departing from the scope of the present disclosure.

The general idea described above with the aid of dipole and loop antennas mainly can be extended to various modifications of and even beyond dipoles and loops. As an example, monopoles are special cases of dipole radiators, where the other branch of the dipole is substituted by a ground plane.

Also in practice it has been demonstrated that the dielectric loading can be placed even on one end of an antenna element only. This is especially beneficial, since the dielectric can be integrated on the plastic shell of the device, like mobile phone, implant etc.

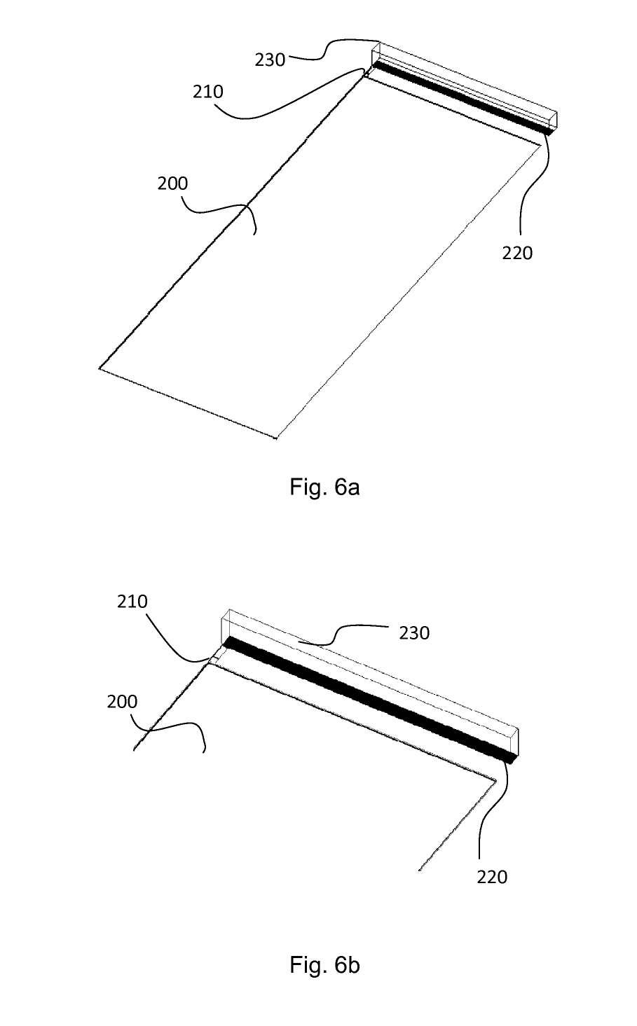

With reference to FIGS. 6-9, a monopole antenna generally comprises at least one dielectric loading element 230, 232, 234, 236 coupled to a portion of a surface of the radiative antenna element which is located on one side of the antenna input 210 and comprising a conductive ground plane 200 located on another side of the antenna input 210.

According to one embodiment, the antenna element is elongated and spaced from the ground plane at an essentially constant distance. The dielectric loading element is typically arranged in the same way.

There may be provided a small conductive piece between the antenna element 220, 222, 224, 226 and the antenna input 210 or the ground plane 200 for separating the antenna element and the ground plane.

According to one embodiment, the antenna element 220, 222, 224, 226 has a length and the dielectric loading element is coupled to the antenna element on at least half the length thereof. In some embodiments, the antenna element is arranged essentially on the whole length of the antenna element.

The dielectric element 230, 232, 234, 236 may be od constant thickness and width.

FIGS. 6a and 6b shows in detail one monopole variation of the invention. The antenna element 220 has been arranged essentially on the same plane as the planar ground plane 200 but separated therefrom in in-plane direction. The dielectric element 230 is provided on the top surface of the antenna element 220, extending perpendicularly away from them.

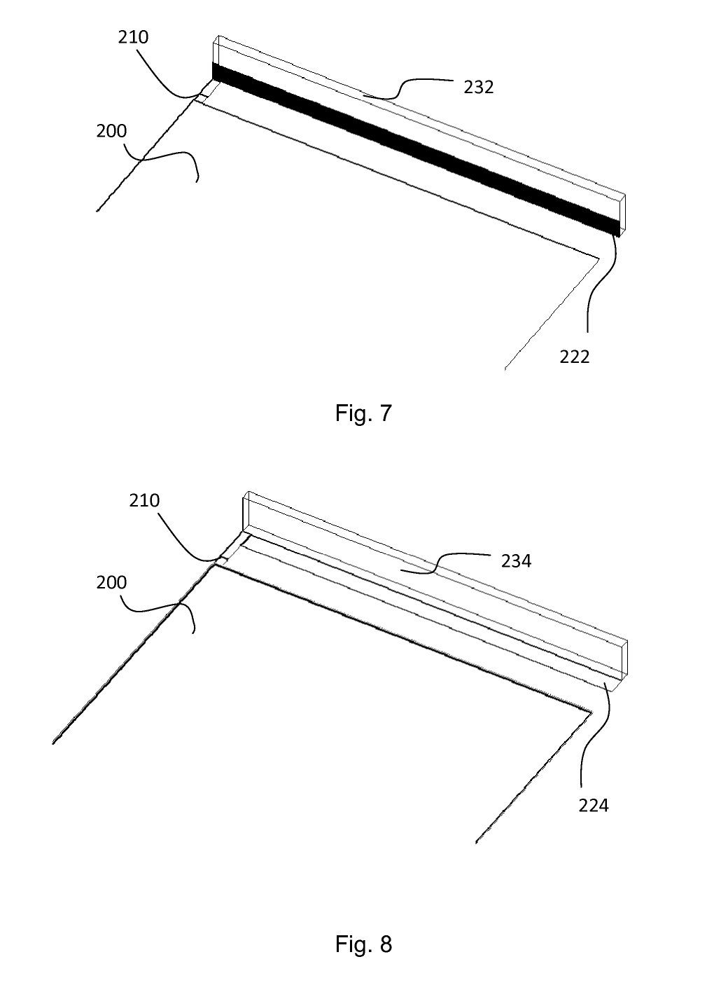

FIG. 7 shows another monopole variation of the invention. The antenna element 222 has been arranged in tilted (90 degrees) orientation with respect to the planar ground plane 200 and separated therefrom. The dielectric element 232 is provided on a surface of the antenna element 222, extending away from the ground plane in in-plane direction.

FIG. 8 shows in detail another monopole variation of the invention. The antenna element 224 has been arranged essentially on the same plane as the planar ground plane 200 but separated therefrom and the dielectric element 230 is provided cornerwise to the antenna element 224, extending perpendicularly away from them.

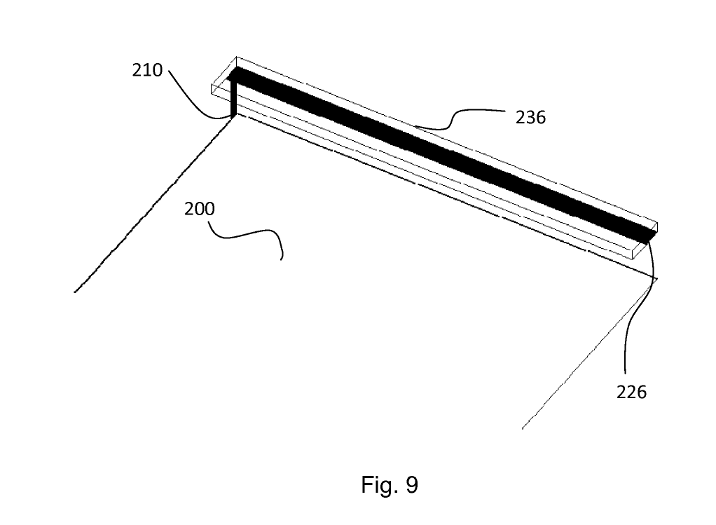

FIG. 9 shows still another monopole variation of the invention. The antenna element 226 has been arranged coplanar with the planar ground plane 200 and separated therefrom an out-of-plane direction. The dielectric element 232 is provided on a surface of the antenna element 226, extending away from the ground plane.

Variations and combinations of the embodiments discussed above are possible.

In all of the embodiments discussed above and in the appended claims, the antenna element is preferably metallic in order to ensure sufficient conductivity and radiativity.

According to a preferred embodiment the dielectric loading element or elements have the following electric properties: relative permittivity εᵣ>7 and dissipation factor tan d<0.01.

The scope of the invention is not limited to the embodiments described above and shown in the drawings, but is defined in the following claims.

1. A loaded antenna comprising,
a radiative antenna element, and
an antenna input located on the radiative antenna element at a first position,
wherein
at least one set of opposing dielectric loading elements are separated by a gap and coupled to a portion of a surface of the radiative antenna element, or
at least one dielectric loading element is coupled to a portion of a surface of the radiative antenna element which is located on one side of the antenna input and comprising a conductive ground plane located on another side of the antenna input.

2. A loaded antenna according to claim 1, further comprising at least one set of opposing dielectric loading elements separated by a gap.

3. A loaded antenna according to claim 2, wherein the dielectric loading elements are arranged at least partly on top of a surface of the antenna element and have a height measured from said surface.

4. A loaded antenna according to claim 2, wherein the antenna element is a dipole element having a length along a first axis defined by a first and second peripheral end of the dipole element.

5. A loaded antenna according to claim 2, wherein the antenna element is a loop element having a length along a first axis defined by a first and second peripheral end of the loop element.

6. A loaded antenna according to claim 3, further comprisingᵢ
a first dielectric structure of the set of opposing dielectric loading elements having a first height, a first width and extending a first distance substantially from the first peripheral end along the first axis, and
a second dielectric structure of the set of opposing dielectric loading elements having a second height, a second width and extending a second distance substantially from the second terminal end along the first axis,
wherein the first height, width and distance are substantially similar to the second height, width and distance.

7. A loaded antenna according to claim 6 wherein,
the first height is constant along the entire first width of the first dielectric structure, and
the second height is constant along the entire second width of the second dielectric structure.

8. A loaded antenna according to claim 6 wherein,
the first height varies along either the first width, the first distance or along both the first width and the first distance, and
the second height varies along either the second width, the second distance or along both the second width and the second distance.

9. A loaded antenna according to claim 6, wherein,
the first width is constant along the entire first distance of the first dielectric structure, and
the second width is constant along the entire second distance of the second dielectric structure.

10. A loaded antenna according to claim 6 wherein,
the first width varies along the first distance of the first dielectric structure, and
the second width varies along the second distance of the second dielectric structure.

11. A loaded antenna according to claim 9, wherein the antenna element is a dipole element whose width varies along its length and the first and second widths are substantially similar to the width of the dipole along the first and second distances respectively.

12. A loaded antenna according to claim 1, further comprising two sets of opposing dielectric loading elements arranged on different sides of the antenna element.

13. A loaded antenna according to claim 6, further comprising:
a third dielectric structure, attached to the surface opposite of the surface supporting the first dielectric structure, having a third height, a third width and extending a first distance substantially from the first terminal end along the length of the dipole element, and
a fourth dielectric structure, attached to the surface opposite of the surface supporting the second dielectric structure, having a fourth height, a fourth width and extending a second distance substantially from the second terminal end along the length of the dipole element.

14. A loaded antenna according to claim 13 wherein,
the third dielectric structure is substantially similar to the first dielectric structure, and
the fourth dielectric structure is substantially similar to the second dielectric structure.

15. A loaded antenna according to claim 2 wherein,
the antenna element has at least two opposing surfaces defining a thickness,
the at least one set of loading elements are both attached to the same surface by either Printed Circuit Board process or Integrated Passive Device process, and
the dielectric structure heights extending perpendicular to the plane of the attached surface and away from the opposing surface.

16. A loaded antenna according to claim 2, wherein the gap between the at least one set of dielectric loading elements is between 10% and 90% of the corresponding dimension of the antenna element.

17. A loaded antenna according to claim 2, wherein the length of the loading elements in the direction spanned by the set of loading elements is 30-50% of the corresponding dimension of the antenna element divided by two.

18. A loaded antenna according to claim 1, wherein the maximum height of any of the dielectric structures is less than 5% of the operating wavelength of the antenna.

19. A loaded antenna according to claim 2 which is essentially symmetrical about the antenna input.

20. A loaded antenna according to claim 1, wherein the loading elements are ceramic.

21. The loaded antenna according to claim 1, wherein the antenna element is a monopole element.

22. The loaded antenna according to claim 21, wherein the antenna element has a length and the dielectric loading element is coupled to the antenna element on at least half the length thereof.

23. The loaded antenna according to claim 21, wherein the antenna element is elongated and spaced from the ground plane at an essentially constant distance.

24. The loaded antenna according to claim 1, wherein the antenna element is metallic.

25. The loaded antenna according to claim 1, wherein the dielectric loading element(s) has/have the following electric properties: a relative permittivity εᵣ>7 and a dissipation factor tan d<0.01.
